(19) United States
(12) Patent Application Publication
(10) Pub. No.: US 2003/0103301 A1
(43) Pub. Date: Jun. 5, 2003

(54) On chip smart capacitors

(76) Inventor: Paul S. Fechner, Plymouth, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/006,470

(22) Filed: Dec. 3, 2001

(51) Int. Cl. H01G 2/12

(52) U.S. Cl. 361/15

(57) ABSTRACT

A semiconductor chip has first and second power supply lines and a capacitor having first and second capacitive electrodes. The first capacitive electrode is coupled to the first power supply line. A transistor has first and second current carrying electrodes and a control electrode. The first current carrying electrode is coupled to the second capacitive electrode, and the second current carrying electrode is coupled to the second power supply line. A logic controller is coupled to the second capacitive electrode and to the control electrode. The logic controller is effective to detect a defect in the capacitor and to operate the transistor so as to disconnect the capacitor from the first and second power supply lines in the event that the logic controller detects a defect in the capacitor.

### TECHNICAL FIELD OF THE INVENTION

The present invention relates to power supply capacitors for use on integrated circuits.

### BACKGROUND OF THE INVENTION

In many integrated circuit applications, it is desirable to provide on-chip capacitors coupled to the chip's power supply in order to minimize power supply noise associated with the transients caused by the switching of the transistors located on the chip. Forming such capacitors in the unused area of a chip would efficiently use chip area. However, the typical defect density of on-chip gate oxide capacitors is frequently too high, thus creating significant yield losses and reliability degradation. Accordingly, the amount of gate oxide chip area devoted to bypass capacitors is often limited to a small percentage of the total gate oxide area. This limitation on the use of the gate oxide chip area limits the beneficial effects to only crucial areas of the chip circuitry in order to keep yield losses and reliability degradation to acceptable levels.

The present invention is directed to a smart capacitor that addresses one or more of these problems.

### SUMMARY OF THE INVENTION

In accordance with one aspect of the present invention, a semiconductor chip comprises an on-chip power supply line, an on-chip capacitor coupled to the on-chip power supply line, and an on-chip defect detector coupled to the on-chip capacitor. The on-chip defect detector detects a defect in the on-chip capacitor and disconnects the on-chip capacitor from the on-chip power supply line in the event that the on-chip defect detector detects a defect in the on-chip capacitor.

In accordance with another aspect of the present invention, a semiconductor chip comprises first and second power supply lines, a capacitor having first and second capacitive electrodes, a transistor, and a logic controller. The first capacitive electrode is coupled to the first power supply line. The transistor has first and second current carrying electrodes and a control electrode, the first current carrying electrode is coupled to the second capacitive electrode, and the second current carrying electrode is coupled to the second power supply line. The logic controller is coupled to the second capacitive electrode and to the control electrode. The logic controller is effective to detect a defect in the capacitor and to operate the transistor so as to disconnect the capacitor from the first and second power supply lines in the event that the logic controller detects a defect in the capacitor.

In accordance with yet another aspect of the present invention, a semiconductor chip comprises first and second power supply lines, a plurality of capacitors each having first and second capacitive electrodes, a plurality of transistors each having first and second current carrying electrodes and a control electrode, and a plurality of logic controllers. The first capacitive electrodes of the plurality of capacitors are coupled to the first power supply line. The first current carrying electrode of each of the plurality of transistors is coupled to the second capacitive electrode of a corresponding one of the plurality of capacitors, and the second current carrying electrodes of the plurality of transistors are coupled to the second power supply line. Each of the plurality of logic controllers is coupled to the second capacitive electrode of a corresponding one of the plurality of capacitors and to the control electrode of a corresponding one of the plurality of transistors, and each of the plurality of logic controllers is effective to detect a defect in its corresponding one of the plurality of capacitors and to operate its corresponding one of the plurality of transistors so as to disconnect its corresponding one of the plurality of capacitors from the first and second power supply lines in the event that the logic controller detects a defect in its corresponding one of the plurality of capacitors.

### BRIEF DESCRIPTION OF THE DRAWINGS

These and other features and advantages of the present invention will become more apparent from a detailed consideration of the invention when taken in conjunction with the drawings in which:

FIG. 1 is a diagram illustrating a plurality of unit size on-chip capacitors coupled to a power supply line of a chip;

FIG. 2 is a schematic diagram of one embodiment of a capacitor and fault detection circuit that can be used in connection with the arrangement shown in FIG. 1; and,

FIG. 3 is a schematic diagram of another embodiment of a capacitor and fault detection circuit that can be used in connection with the arrangement shown in FIG. 1.

### DETAILED DESCRIPTION

According to an embodiment of the present invention, the total on-chip bypass capacitor area is divided up into smaller unit size capacitors which can be coupled independently to the on-chip Vdd/Vss power supply lines. The unit size of a capacitor is chosen so that the disconnection of a few of the unit size capacitors has an acceptably small impact on the total number of on-chip capacitors.

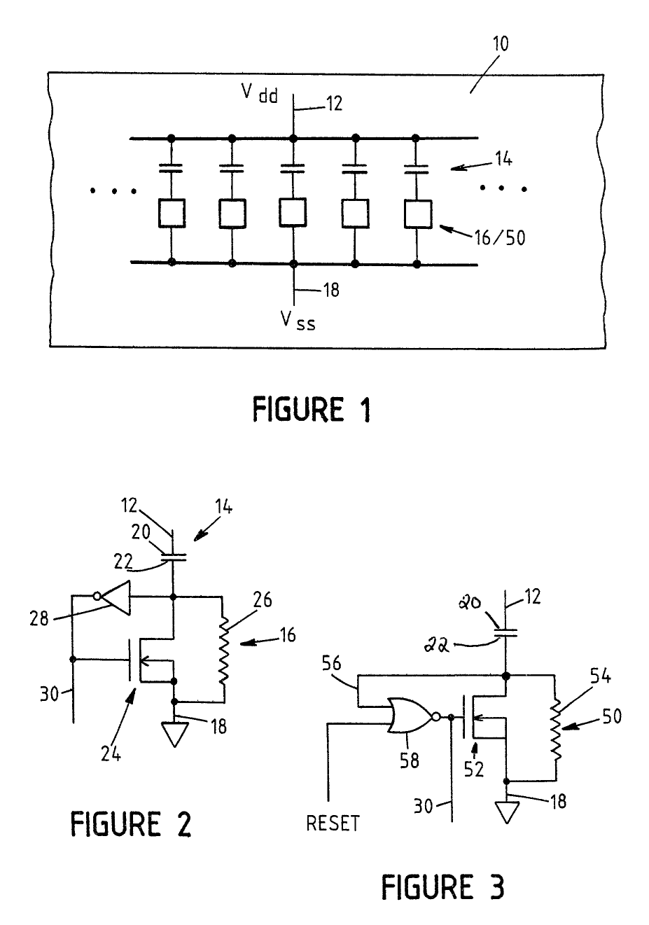

A chip 10 is illustrated in FIG. 1. The chip 10 has a power supply line 12 (e.g., Vdd), which supplies one or more transistors fabricated on the chip 10. Coupled to the supply line 12 is a plurality of on-chip bypass capacitors 14 each of which has a predetermined unit size. The size of each of these on-chip bypass capacitors 14 should be small enough that a plurality of such capacitors can be formed for each supply line.

Each of the on-chip bypass capacitors 14 has an associated detector circuit 16 coupled between the corresponding on-chip bypass capacitor 14 and a power supply terminal 18 (e.g., Vss). Each of the detector circuits 16 detects whether its corresponding on-chip bypass capacitor 14 is defective. If one of the detector circuits 16 detects that its corresponding on-chip bypass capacitor 14 is defective, that detector circuit 16 maintains that on-chip bypass capacitor 14 disconnected from the power supply line 12. On the other hand, if the detector circuit 16 detects that its corresponding on-chip bypass capacitor 14 is not defective, that detector circuit 16 connects that on-chip bypass capacitor 14 to the power supply line 12.

One exemplary embodiment of a representative one of the on-chip bypass capacitors 14 and detector circuits 16 is shown in FIG. 2. A first electrode 20 of the on-chip bypass capacitor 14 shown in FIG. 2 is coupled to the power supply line 12 and a second electrode 22 of the on-chip bypass capacitor 14 is coupled to the power supply line 18 through a transistor 24 and a resistor 26 of the detector circuit 16. As shown in FIG. 2, the resistor 26 is coupled across the source and drain of the transistor 24. The second electrode 22 of the on-chip bypass capacitor 14 and the drain electrode of the transistor 24 are coupled to an input of an inverter 28 whose output drives the gate electrode of the transistor 24.

When the chip 10 is powered up and the on-chip bypass capacitor 14 is not defective, the on-chip bypass capacitor 14 initially maintains the input of the inverter 28 at Vdd so that the output of the inverter is low (i.e., the inverter 28 is OFF). In this state, the transistor 24 is also OFF. However, the resistor 26 discharges the node at the input of the inverter 28 from Vdd until the inverter 28 switches turning the transistor 24 ON so as to ground the second electrode 22 of the on-chip bypass capacitor 14 to Vss. With the second electrode 22 of the on-chip bypass capacitor 14 grounded to the power supply terminal 18, the on-chip bypass capacitor 14 is now effective to ground noise such as may be caused by the switching of any transistors on the chip 10. The size of the transistor 24 is chosen so that its resistance is small enough to enable the on-chip bypass capacitor 14 to act as the desired bypass capacitance.

On the other hand, if the on-chip bypass capacitor 14 is defective at power up, the resistance of the on-chip bypass capacitor 14 is much smaller than the resistance of the resistor 26 such that the input voltage to the inverter 28 will stay high thereby keeping the voltage at the gate of the transistor 24 low to maintain the transistor 24 OFF. In this state, the maximum DC current through the on-chip bypass capacitor 14 and the detector circuit 16 is the current through the resistor 26 with Vdd applied thereacross. The upper limit of the resistance of the resistor 26 is dictated by the normal system expectations as to how soon the chip 10 can be operated after power is applied thereto. The lower limit of the resistance of the resistor 26 is determined by the amount of quiescent current the system can tolerate per defective capacitor. Alternatively, these criteria can be met, for example, by the use of low voltage transistors often available in normal process flows, and the creation of a leaky drain terminal for the transistor 24 by creating a leaky Schottky diode as part of the drain terminal of the transistor 24.

It is noted that the output of the inverter 28 at a terminal 30 is a digital signal that is indicative of whether the corresponding on-chip bypass capacitor 14 is defective. Therefore, various additional circuitry can be added to the chip 10 to monitor the signal on the terminal 30 in order to provide information on capacitor yield which can then be used to provide an indication of general gate oxide yield and reliability. Thus, the terminal 30 can be used as an on-chip process monitor.

It is further noted that the exemplary embodiment shown in FIG. 2 only works at chip power up. It is, therefore, assumed that any defects occurring during operation of the chip 10 are not sufficient to overdrive the transistor 24. However, a defect that overdrives the transistor 24 may occur, because the resistance of the transistor 24 must be low enough to avoid interference with the purpose of the on-chip bypass capacitors 14.

Moreover, while failure of one of the on-chip bypass capacitors 14 may not functionally affect the chip 10 during its operation, this failure can cause a significant increase in the quiescent current that is supplied by the power supply system. This condition can be mitigated by turning OFF the power supply to the chip 10 for a short period of time and by subsequently turning ON the power supply. As a result, any failed on-chip bypass capacitor 14 will be disconnected by the corresponding detector circuit 16 when power is reapplied to the chip 10.

If it is not practical to turn OFF the power supply to the chip 10 for short periods of time during its operation, then the detector circuit 16 shown in FIG. 2 can be replaced by a detector circuit 50 as shown in FIG. 3 to enable a defective capacitor to be removed without interrupting power to the chip 10. Accordingly, as shown in FIG. 3, the first electrode 20 of the on-chip bypass capacitor 14 is coupled to the power supply line 12 and the second electrode 22 of the on-chip bypass capacitor 14 is coupled to the power supply line 18 through a transistor 52 and a resistor 54 of the detector circuit 50. As shown in FIG. 3, the resistor 54 is coupled across the source and drain of the transistor 52. The second electrode 22 of the on-chip bypass capacitor 14 and the drain electrode of the transistor 52 are coupled to a first input 56 of a NOR gate 58 whose output drives the gate electrode of the transistor 52. The NOR gate 58 also has a second input 60 that receives a RESET signal which is normally low.

When the chip 10 is powered up and the on-chip bypass capacitor 14 is not defective, the on-chip bypass capacitor 14 initially maintains the first input 56 of the NOR gate 58 high at Vdd. Accordingly, the output of the NOR gate 58 is low and the transistor 52 is OFF. However, the resistor 54 discharges the node at the first input 56 of the NOR gate 58 from Vdd until the NOR gate 58 switches its output low thereby turning the transistor 52 ON so as to ground the second electrode 22 of the on-chip bypass capacitor 14 to Vss. With the second electrode 22 of the on-chip bypass capacitor 14 grounded to the power supply terminal 18, the on-chip bypass capacitor 14 is now effective to ground noise such as may be caused by the switching of any transistors on the chip 10. The size of the transistor 52 is chosen so that its resistance is small enough to enable the on-chip bypass capacitor 14 to act as the desired bypass capacitance.

However, if the on-chip bypass capacitor 14 is defective at power up, the resistance of the on-chip bypass capacitor 14 is much smaller than the resistance of the resistor 54 such that the first input 56 of the NOR gate 58 remains high thereby keeping the voltage at the gate of the transistor 52 low to maintain the transistor 52 OFF. In this state, the on-chip bypass capacitor 14 does act as the desired bypass capacitance.

While the transistor 52 is ON, the second electrode 22 is maintained at a low voltage which causes to the output of the NOR gate 58 to be high keeping the transistor 52 ON. Thus, if the on-chip bypass capacitor 14 becomes defective after the chip 10 has been in operation, the second electrode 22 will not assume a high enough voltage on its own to drive the output of the NOR gate 58 low to switch OFF the transistor 52. However, the RESET signal may be periodically driven high for an amount of time sufficient to switch the output of the NOR gate 58 low and to thereby switch the transistor 52 OFF. While the transistor 52 is OFF, the on-chip bypass capacitor 14 ceases acting as the desired bypass capacitance, and the defect in the on-chip bypass capacitor 14 pulls the first input 56 of the NOR gate 58 to Vdd. When the potential on the first input 56 of the NOR gate 58 is pulled to Vdd, the output of the NOR gate 58 is held low to maintain the transistor OFF. Accordingly, after the RESET signal resumes it low state, the transistor 58 is still maintained in its OFF state so that the on-chip bypass capacitor 14 is maintained inactive.

All of the RESET lines for all of the capacitors 14 on the chip 10 may be tied together and may be coupled to an input pin of the chip 10. Thus, the system in which the chip 10 is used may determine when to drive the RESET signals high, how often to drive the RESET signals high, and for how long each RESET signal is to remain high. It may be desirable to discontinue the operation of the chip 10 during each period when the RESET signals are high because all of the on-chip bypass capacitors 14 on the chip 10 will be simultaneously disabled, possibly affecting chip noise margins.

Alternatively, the RESET lines of the chip 10 may be driven high sequentially by either an on-chip circuit or by the use of separate pins controlled by an off-chip circuit. Because only one of the on-chip bypass capacitors 14 is reset at a time, and because the size of each of the on-chip bypass capacitors 14 is a small fraction of the total on-chip capacitance, sequential resetting of the on-chip bypass capacitors 14 will have no substantive effect on circuit operation. This sequential resetting approach effectively guarantees that the chip 10 will repair itself within some specifiable time of defect occurrence.

Certain modifications of the present invention have been discussed above. Other modifications will occur to those practicing in the art of the present invention. For example, in the exemplary embodiments of the invention shown in FIGS. 2 and 3, the resistors 26 and 54 are coupled across the drain and source terminals of the transistors 24 and 52, respectively. However, if the OFF state leakage through the transistors 24 and 52 are high enough, the resistors 26 and 54 are unnecessary.

Moreover, although one set of power supply lines 12 and 18 and one plurality of capacitors 14 have been shown in FIG. 1 for the chip 10, it should be understood that each set of power supply lines on the chip 10 may have associated therewith a corresponding plurality of capacitors and associated detector circuits.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A semiconductor chip comprising:
an on-chip power supply line;
an on-chip capacitor coupled to the on-chip power supply line; and,
an on-chip defect detector coupled to the on-chip capacitor, wherein the on-chip defect detector is arranged to detect a defect in the on-chip capacitor and to disconnect the on-chip capacitor from the on-chip power supply line in the event that the on-chip defect detector detects a defect in the on-chip capacitor.

2. The semiconductor chip of claim 1 wherein the on-chip defect detector comprises:
a switch coupled to the on-chip capacitor; and,
a switch controller coupled to the on-chip capacitor and to the switch, whereby the switch controller closes the switch to activate the on-chip capacitor when the on-chip capacitor is not defective and opens the switch to deactivate the on-chip capacitor when the on-chip capacitor is defective.

3. The semiconductor chip of claim 2 wherein the switch comprises a transistor having first and second current carrying electrodes and a control electrode, wherein the first current carrying electrode is coupled to the on-chip capacitor, wherein the switch controller comprises an inverter having an input and an output, wherein the input of the inverter is coupled to a junction of the on-chip capacitor and the first current carrying electrode of the transistor, and wherein the output of the inverter is coupled to the control electrode of the transistor.

4. The semiconductor chip of claim 3 wherein the on-chip defect detector further comprises a resistor coupled across the first and second current carrying electrodes of the transistor.

5. The semiconductor chip of claim 3 wherein the transistor comprises a leaky transistor that permits the on-chip defect detector to function without a resistor coupled to the on-chip capacitor.

6. The semiconductor chip of claim 3 wherein, when the semiconductor chip is powered up and the on-chip capacitor is not defective, the on-chip capacitor initially maintains the input of the inverter at a potential commensurate with a potential on the on-chip power supply line and thereafter the input of the inverter is discharged so that the inverter turns ON the transistor in order activate the on-chip capacitor.

7. The semiconductor chip of claim 3 wherein, when the semiconductor chip is powered up and the on-chip capacitor is defective, the on-chip capacitor maintains the input of the inverter at a potential so that the inverter maintains the transistor in an OFF state thereby keeping the on-chip capacitor disconnected from the on-chip power supply line.

8. The semiconductor chip of claim 2 wherein the switch comprises a transistor having first and second current carrying electrodes and a control electrode, wherein the first current carrying electrode is coupled to the on-chip capacitor, wherein the switch controller comprises a NOR gate having first and second inputs and an output, wherein the first input of the NOR gate is coupled to a junction of the on-chip capacitor and the first current carrying electrode of the transistor, wherein the second input of the NOR gate receives a RESET signal, and wherein the output of the NOR gate is coupled to the control electrode of the transistor.

9. The semiconductor chip of claim 8 wherein the on-chip defect detector further comprises a resistor coupled across the first and second current carrying electrodes of the transistor.

10. The semiconductor chip of claim 8 wherein the transistor comprises a leaky transistor that permits the on-chip defect detector to function without a resistor coupled to the on-chip capacitor.

11. The semiconductor chip of claim 8 wherein, when the semiconductor chip is powered up and the on-chip capacitor is not defective, the on-chip capacitor initially maintains the first input of the NOR gate at a potential commensurate with a potential on the on-chip power supply line and thereafter the first input of the NOR gate is discharged so that the NOR gate turns ON the transistor in order activate the on-chip capacitor.

12. The semiconductor chip of claim 8 wherein, when the semiconductor chip is powered up and the on-chip capacitor is defective, the on-chip capacitor maintains the first input of the NOR gate at a potential so that the NOR gate maintains the transistor in an OFF state thereby keeping the on-chip capacitor disconnected from the on-chip power supply line.

13. The semiconductor chip of claim 8 wherein, when the semiconductor chip has been in an operational state and the on-chip capacitor becomes defective, the second input of the NOR gate is momentarily driven high so that the NOR gate switches the transistor OFF thereby disconnecting the on-chip capacitor from the on-chip power supply line even after the second input of the NOR gate resumes a low state.

14. The semiconductor chip of claim 2 wherein:
when the semiconductor chip is powered up and the on-chip capacitor is not defective, the on-chip capacitor initially maintains an input of the switch controller at a potential commensurate with a potential on the on-chip power supply line and the switch controller, in response to the potential, maintains the switch open; and,
after power up of the semiconductor chip, the input of the switch controller is discharged so that the switch controller closes the switch in order activate the on-chip capacitor.

15. The semiconductor chip of claim 2 wherein, when the semiconductor chip is powered up and the on-chip capacitor is defective, the on-chip capacitor maintains an input of the switch controller at a potential so that the switch controller maintains the switch open thereby keeping the on-chip capacitor disconnected from the on-chip power supply line.

16. The semiconductor chip of claim 2 wherein, when the semiconductor chip has been operational and the on-chip capacitor becomes defective, the switch controller drives the switch momentarily open to thereby disconnect the on-chip capacitor from the on-chip power supply line and the defective on-chip capacitor maintains the switch open to thereby maintain the on-chip capacitor disconnected.

17. The semiconductor chip of claim 1 wherein the on-chip defect detector is effective to disconnect the on-chip capacitor from the on-chip power supply line only upon power-up of the semiconductor chip.

18. The semiconductor chip of claim 1 wherein the on-chip defect detector is effective to disconnect the on-chip capacitor from the on-chip power supply line at any time following power-up of the semiconductor chip.

19. A semiconductor chip comprising:
first and second power supply lines;
a capacitor having first and second capacitive electrodes, wherein the first capacitive electrode is coupled to the first power supply line;
a transistor having first and second current carrying electrodes and a control electrode, wherein the first current carrying electrode is coupled to the second capacitive electrode, and wherein the second current carrying electrode is coupled to the second power supply line; and,
a logic controller coupled to the second capacitive electrode and to the control electrode, wherein the logic controller is effective to detect a defect in the capacitor and to operate the transistor so as to disconnect the capacitor from the first and second power supply lines in the event that the logic controller detects a defect in the capacitor.

20. The semiconductor chip of claim 19 further comprising a resistor coupled across the first and second current carrying electrodes.

21. The semiconductor chip of claim 19 wherein the transistor comprises a leaky transistor that permits the logic controller to function without a resistor coupled between the capacitor and the transistor.

22. The semiconductor chip of claim 19 wherein:
when the semiconductor chip is powered up and the capacitor is not defective, the second capacitive electrode initially maintains an input of the logic controller at a potential commensurate with a potential on the first power supply line and the logic controller, in response to the potential, maintains the transistor in an OFF state; and,
after power up of the semiconductor chip, the input of the logic controller is discharged so that the logic controller turns the transistor ON in order activate the capacitor.

23. The semiconductor chip of claim 19 wherein, when the semiconductor chip is powered up and the capacitor is defective, the second capacitive electrode maintains an input of the logic controller at a potential of the first power supply line so that the logic controller maintains the transistor in an OFF state thereby keeping the capacitor disconnected from the first and second power supply lines.

24. The semiconductor chip of claim 19 wherein the logic controller is effective to control the transistor so as to disconnect the capacitor from the first and second power supply lines only upon power-up of the semiconductor chip.

25. The semiconductor chip of claim 19 wherein the logic controller is effective to control the transistor so as to disconnect the capacitor from the first and second power supply lines at any time following power-up of the semiconductor chip.

26. The semiconductor chip of claim 19 wherein, when the semiconductor chip has been operational and the capacitor becomes defective, the logic controller is responsive to a pulse so as to drive the transistor momentarily to an OFF state to thereby disconnect the capacitor from the first and second power supply lines and, if the on-chip capacitor is defective, the logic controller controls the transistor so as to maintains the capacitor disconnected from the first and second power supply lines following the pulse.

27. The semiconductor chip of claim 19 wherein the logic controller comprises an inverter.

28. The semiconductor chip of claim 19 wherein the logic controller comprises a NOR gate.

29. A semiconductor chip comprising:
first and second power supply lines;
a plurality of capacitors each having first and second capacitive electrodes, wherein the first capacitive electrodes of the plurality of capacitors are coupled to the first power supply line;
a plurality of transistors each having first and second current carrying electrodes and a control electrode, wherein the first current carrying electrode of each of the plurality of transistors is coupled to the second capacitive electrode of a corresponding one of the plurality of capacitors, and wherein the second current carrying electrodes of the plurality of transistors are coupled to the second power supply line; and,
a plurality of logic controllers each coupled to the second capacitive electrode of a corresponding one of the plurality of capacitors and to the control electrode of a corresponding one of the plurality of transistors, wherein each of the plurality of logic controllers is effective to detect a defect in its corresponding one of the plurality of capacitors and to operate its corresponding one of the plurality of transistors so as to disconnect its corresponding one of the plurality of capacitors from the first and second power supply lines in the event that the logic controller detects a defect in its corresponding one of the plurality of capacitors.

30. The semiconductor chip of claim 29 further comprising a plurality of resistors each coupled across the first and second current carrying electrodes of a corresponding one of the plurality of transistors.

31. The semiconductor chip of claim 29 wherein each of the plurality of transistors comprises a leaky transistor that permits its corresponding logic controller to function without a resistor coupled to its corresponding capacitor.

32. The semiconductor chip of claim 29 wherein:
when the semiconductor chip is powered up and at least one of the capacitors is not defective, the second capacitive electrode of the at least one non-defective capacitor initially maintains an input of its corresponding logic controller at a potential commensurate with a potential on the first power supply line, and its corresponding logic controller, in response to the potential, maintains its corresponding transistor in an OFF state; and,
after power up of the semiconductor chip, the input of the corresponding logic controller is discharged that the corresponding logic controller turns its corresponding transistor ON in order activate the at least one non-defective capacitor.

33. The semiconductor chip of claim 29 wherein, when the semiconductor chip is powered up and at least one of the capacitors is defective, the second capacitive electrode of the at least one defective capacitor maintains an input of its corresponding logic controller at a potential of the first power supply line so that the corresponding logic controller maintains its corresponding transistor in an OFF state thereby keeping the at least one defective capacitor disconnected from the first and second power supply lines.

34. The semiconductor chip of claim 29 wherein at least some of the plurality of logic controllers are effective to control corresponding ones of the plurality of transistors so as to disconnect corresponding ones of the plurality of capacitors from the first and second power supply lines only upon power-up of the semiconductor chip.

35. The semiconductor chip of claim 29 wherein at least some of the logic controllers are effective to control corresponding ones of the plurality of transistors so as to disconnect corresponding ones of the plurality of capacitors from the first and second power supply lines at any time following power-up of the semiconductor chip.

36. The semiconductor chip of claim 29 wherein, when the semiconductor chip has been operational and at least one of the capacitors becomes defective, one of the plurality of logic controllers corresponding to the at least one defective capacitor is responsive to a pulse in order to drive its corresponding transistor momentarily to an OFF state to thereby disconnect the at least one defective capacitor from the first and second power supply lines and, if the at least one defective capacitor is defective, its corresponding logic controller controls its corresponding transistor so as to maintain the at least one defective capacitor disconnected from the first and second power supply lines following the pulse.

37. The semiconductor chip of claim 36 wherein the logic controllers are pulsed simultaneously.

38. The semiconductor chip of claim 36 wherein the logic controllers are pulsed sequentially.

39. The semiconductor chip of claim 29 wherein each of at least some of the logic controllers comprises an inverter.

40. The semiconductor chip of claim 29 wherein each of at least some of the logic controllers comprises a NOR gate.
